(19) United States
(12) Patent Application Publication
(10) Pub. No.: US 2015/0039335 A1
(43) Pub. Date: Feb. 5, 2015

(54) SYSTEM AND METHOD FOR MEDICAL PATIENT INTERACTION

(71) Applicant: Ardavan Saidi, Miami Beach, FL (US)

(72) Inventor: Ardavan Saidi, Miami Beach, FL (US)

(21) Appl. No.: 14/449,480

(22) Filed: Aug. 1, 2014

Related U.S. Application Data
(60) Provisional application No. 61/860,996, filed on Aug. 1, 2013.

(51) Int. Cl. G06Q 50/22; G06Q 10/10

(52) U.S. Cl. CPC G06Q 50/22; G06Q 10/1095
USPC 705/2

(57) ABSTRACT

The present invention is a system and method communication dental information and selecting a dentist whereby said system has a program placed on a computing device, a central database whereby individual dentist offices are able to register their dental office and information;

a consumer interaction portal whereby said portal includes at least one of information about a dental office based on location, consumer reviews, prices, available coupons and combinations thereof, whereby said consumer accesses said dental database through an integrated application program on a mobile device.

### INDEX TO RELATED APPLICATIONS

This application is a non-provisional of and claims benefit to U.S. Provisional Patent Application Ser. No. 61/860,996 filed Aug. 1, 2013 the disclosure of which is incorporated herein by reference in its entirety.

### BACKGROUND OF THE INVENTION

### Field of the Invention

In the current world utilizing information at a touch of a button, it seems becomes difficult to make some decisions. One such decision that becomes difficult is selecting a medical provider, including but not limited to, a dentist or dental health provider. In doing so, most persons rely on either lists provided by their insurance companies of preferred providers or referrals by friends, families, co-workers and the like. However, none of these sources provide the information a consumer truly needs to make an informed decision. An informed decision relates to many factors. The consumer decision can be on any one or combination of the office location, reviews of other patients, pricing, availability of coupons, insurance acceptance, and the like. The system and method of the present invention addresses the shortcomings and provides a comprehensive selective system whereby a consumer can access all of the information needed to make an informed decision.

### SUMMARY OF THE INVENTION

Although, as described in a preferred embodiment, the system is directed to dentists, this is illustrative only and equally applicable for dentistry or any medical professional. Further, as used herein, “consumer” is either an actual patient, or one accessing the system and method of the present invention on behalf of a patient.

In one embodiment, the system is a system and method communication dental information and selecting a dentist whereby said system comprises:
a program configured to be placed on a mobile computing device;
a central database whereby individual dentist offices are able to register their dental office and information;

a consumer interaction portal whereby said portal includes at least one of information about a dental office based on location, consumer reviews, prices, available coupons and combinations thereof;
whereby said consumer accesses said dental database through an integrated application program on a mobile device.

The consumer access includes restriction identifiers resulting in generation of a list from said database based on said restrictions.

Additionally, the dentist receives contact information based on views of office registration information and the consumer can schedule an appointment for a selected dentist.

In one embodiment, the present invention is a method of making a dental appointment, said method comprising the steps of:

providing a system of the present invention;

accessing said system by a patient or patient caregiver;

searching said system by selecting at least one search parameter;

outputting a list of providers based on the search parameters.

### BRIEF DESCRIPTION OF THE SEVERAL VIEWS OF THE DRAWING

FIG. 1 is a screen shot of a home screen of an application on a mobile device.

FIG. 2 is a screen shot of a screen on a mobile device prompting for login or sign in.

FIG. 3 is a screen shot from a mobile device describing the application and program.

FIG. 4 is a screen shot showing sponsored links in the system of the present invention.

FIG. 5 is a screen shot showing participating dentists within proximity of the currently located mobile device.

FIG. 6 is a screen shot of a particularly selected dentist.

FIG. 7 is a screen shot of the in box of a mobile device using the present invention.

FIG. 8 is a screen shot of a coupon utilizing the present invention.

FIG. 9 is a screen shot of a plurality of coupons varying dental providers.

FIG. 10 is a screen shot whereby the prices for dental services are listed.

FIG. 11 is a screen shot of a mobile device showing reviews according to the system of the present invention.

FIG. 12 is a screen shot of the system of the present invention shown on a mobile device whereby directions to a selected dentist's office are displayed.

FIG. 13 is a flow chart of the present invention when used by the consumer.

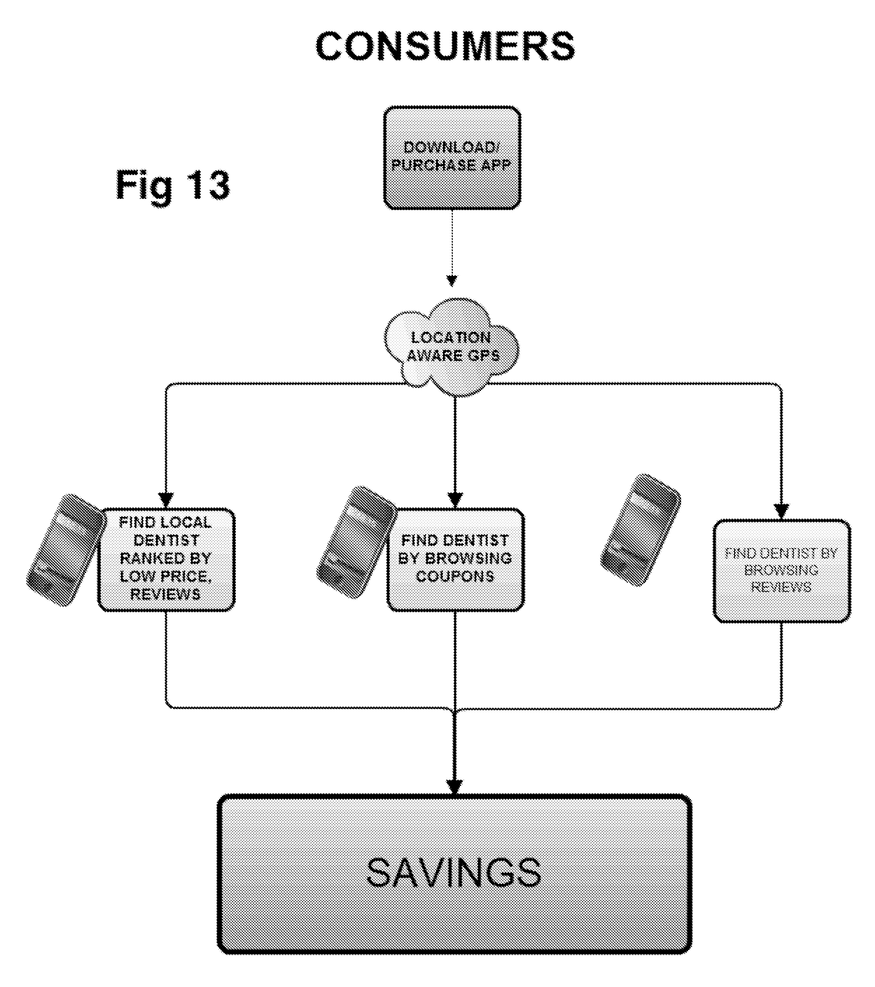

FIG. 14 is a flow chart of the present invention when used by the dentist.

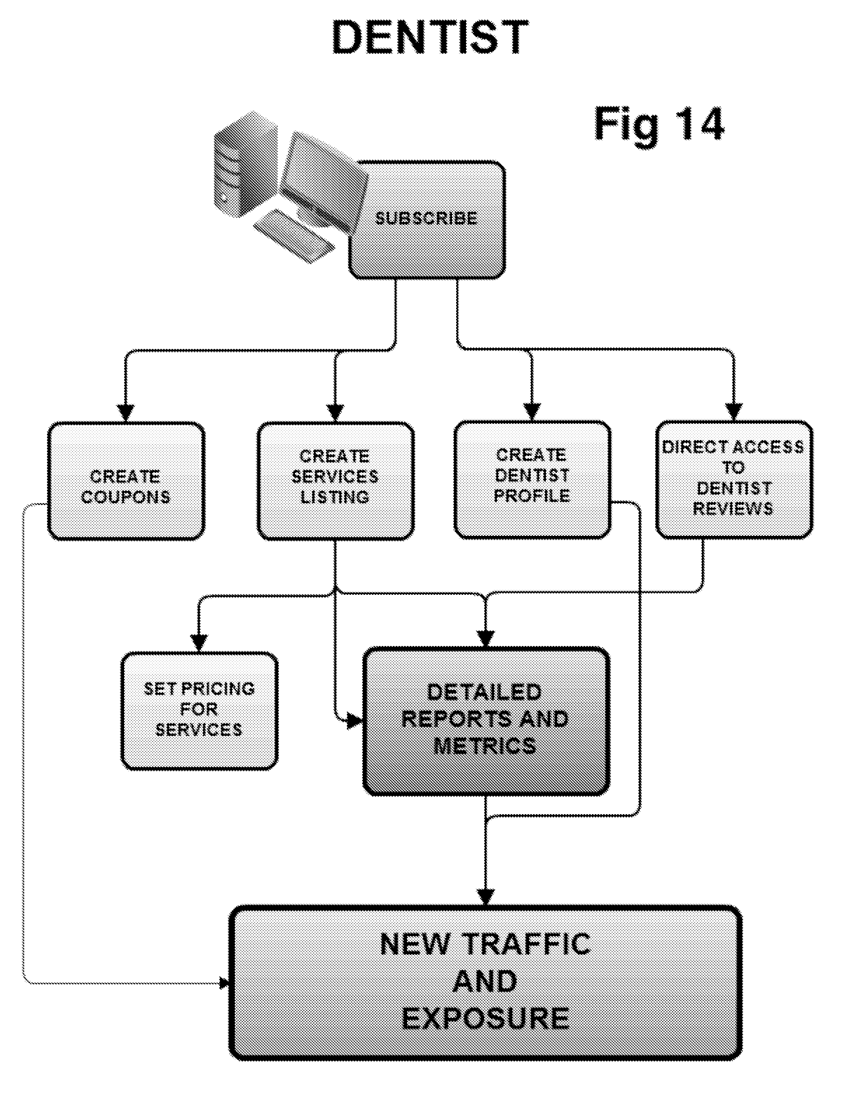

### DETAILED DESCRIPTION OF THE PREFERRED EMBODIMENT

The present invention relates to a system and method whereby medical providers and patients are able to interact. Although specific embodiments are presented relating to dentists, the impetus of the system and method of the present invention is applicable in other fields.

In a preferred embodiment, dentists and dental health providers are able to promote and access potential and current patients using the system in conjunction with a computer device. In one embodiment, the patient will use a smart phone or mobile computing device in order to access the system. It is generally known and understood that currently, dental health providers receive new patients either by current patient referrals or by inclusion on preferred provider lists such as those of insurance companies. The system of the present invention provides a consumer with the ability to receive information relating to consumer or patient reviews of a particular dentist as well as pricing available at a particular dental office. This allows a consumer to truly be informed as to the cost of services being sought. The system is constructed and arranged such that a dentist subscribes to the system and subscription information is included in the database.

Upon subscription, the dentist has an option to do any one or all of the following being: create coupons, create services listings, create a dentist profile, create access to dentist reviews and set pricing for services. The information input by the dentist is processed and formed into a detailed report searchable by a consumer. The report is sorted by any of pricing, location and dental reviews. It is understood that the report can be sorted by any one or all of these. A consumer, being a patient, caretaker of a patient, or person searching for dental services on behalf of patient will access the system typically by downloading of an application program to a smart phone or mobile computing device. The application will include the ability to locate the physical location of the smart phone or mobile computing device. Alternatively, the system will ask for an address or zip code in which to search. The system will then allow the consumer to sort dentists' listings by any one or combination of location, price, reviews, or coupons as demonstrated by the various figures, the consumer will then have the ability to select a particular dentist.

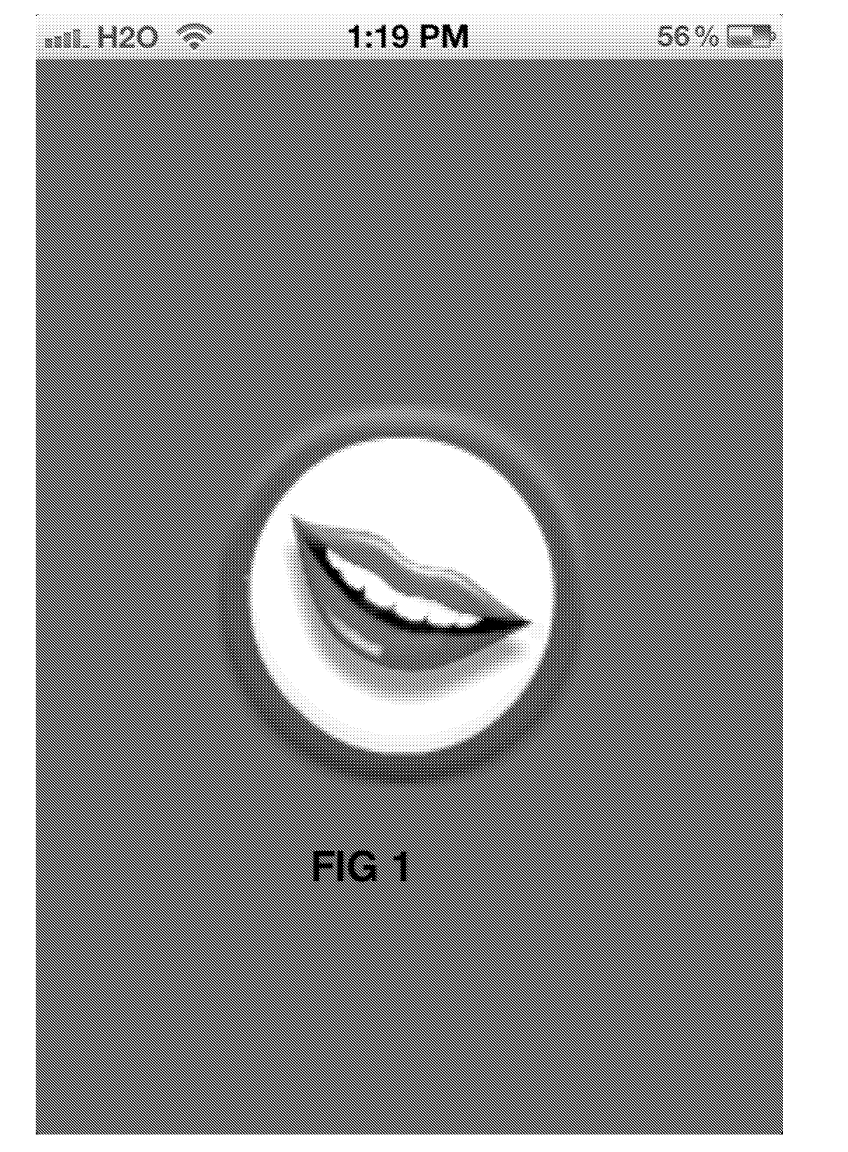

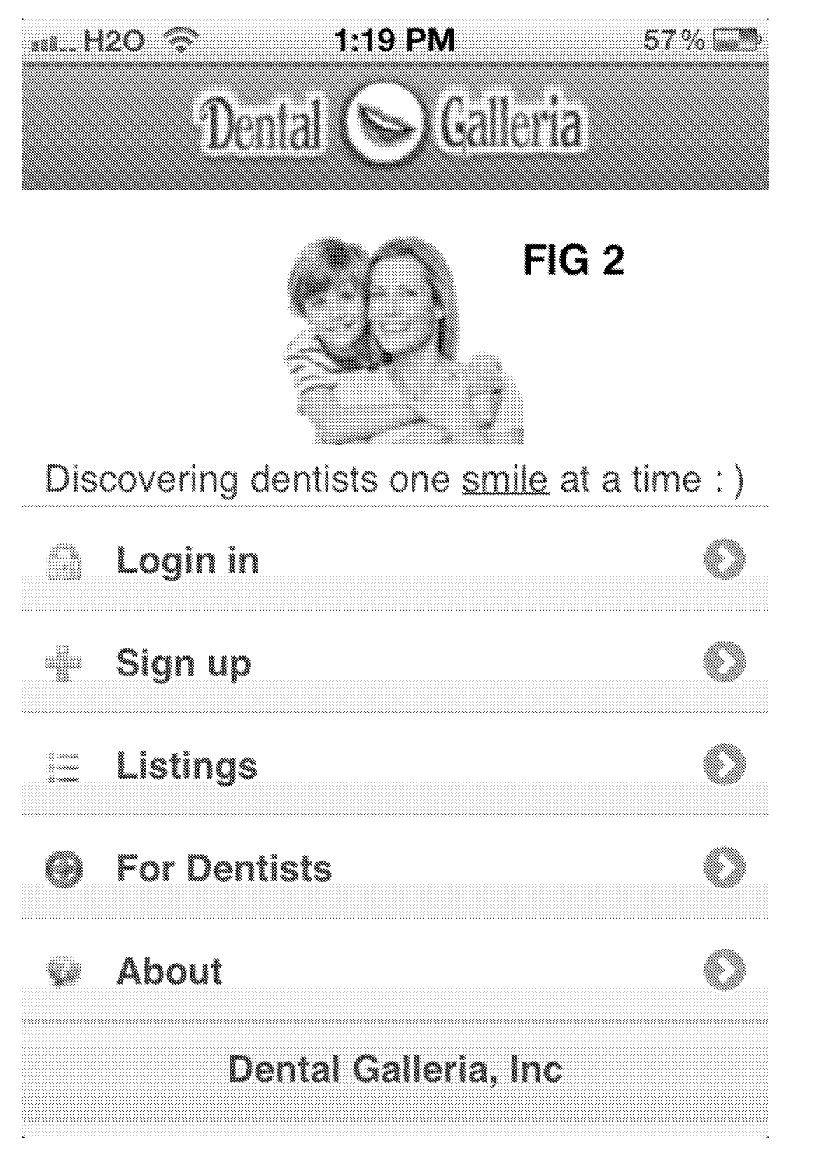

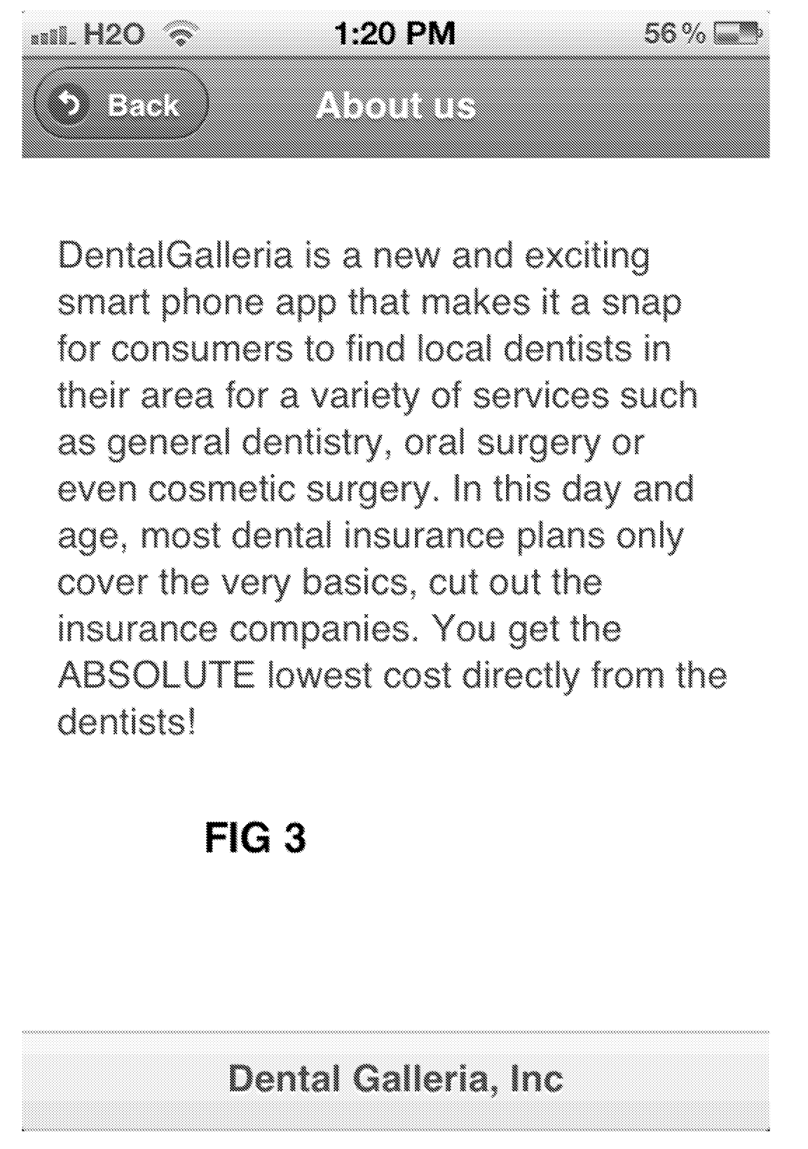

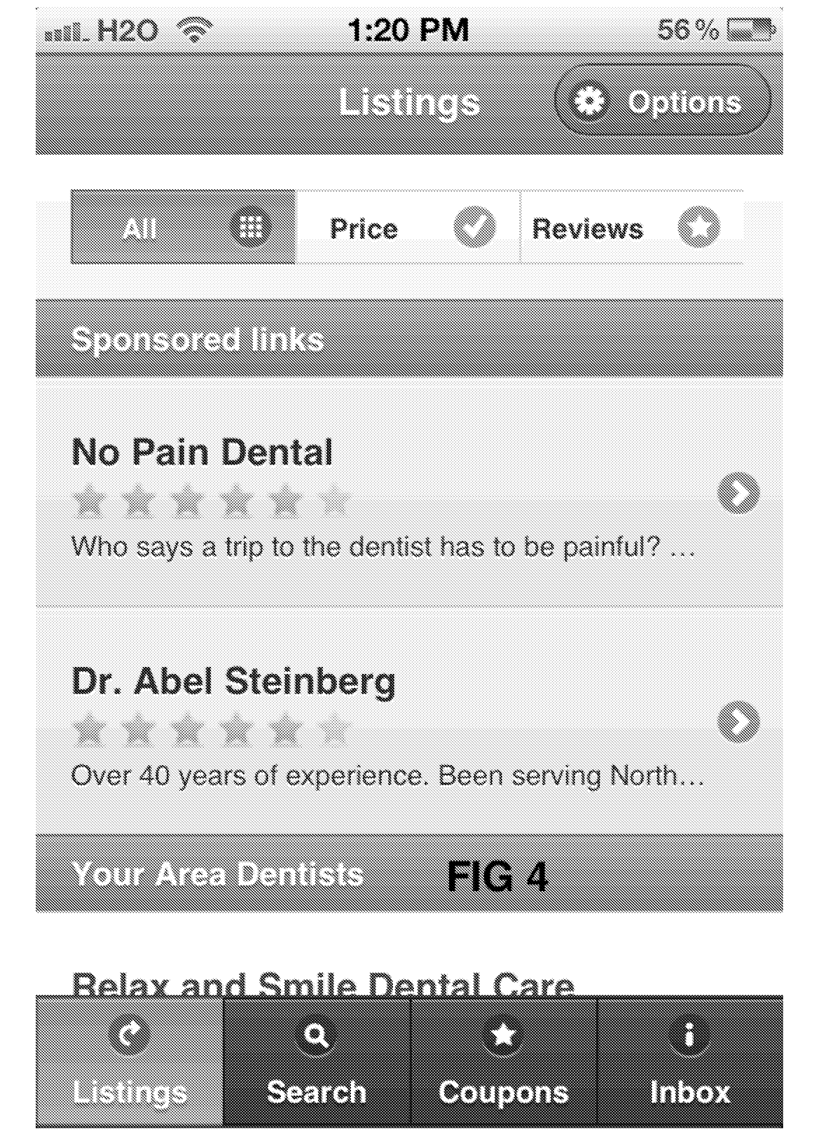

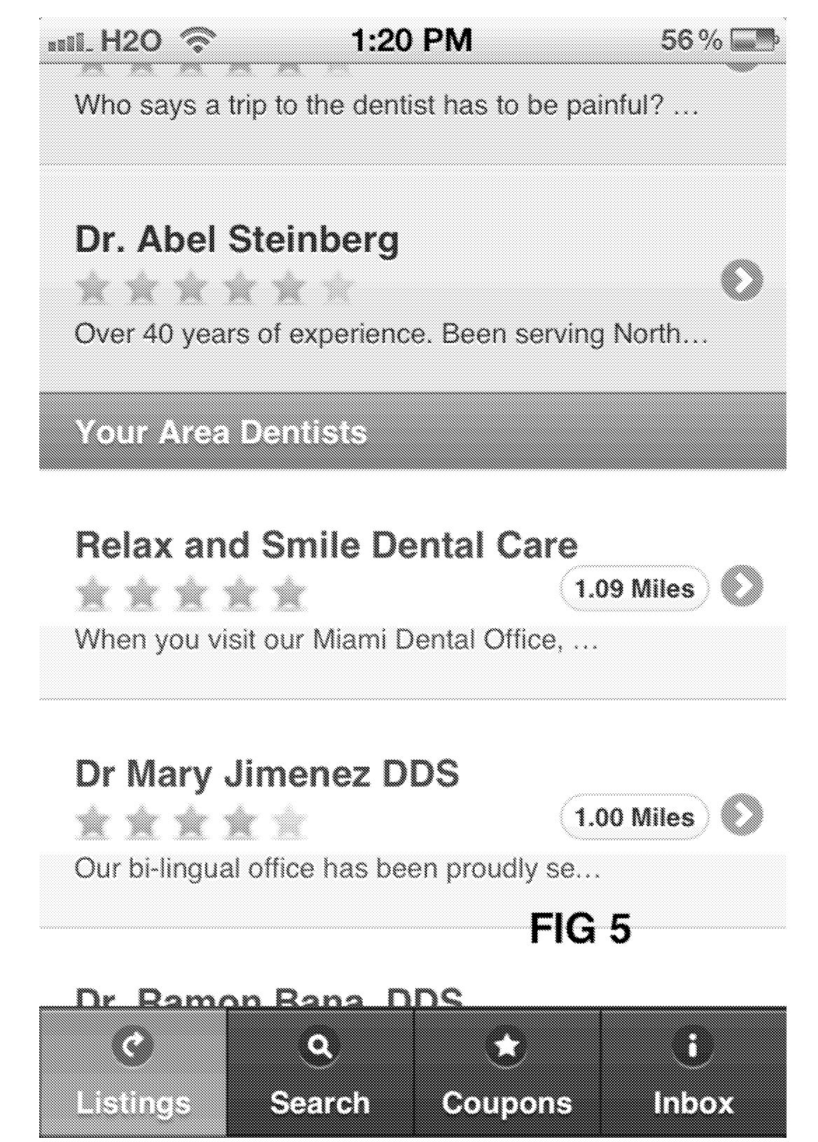

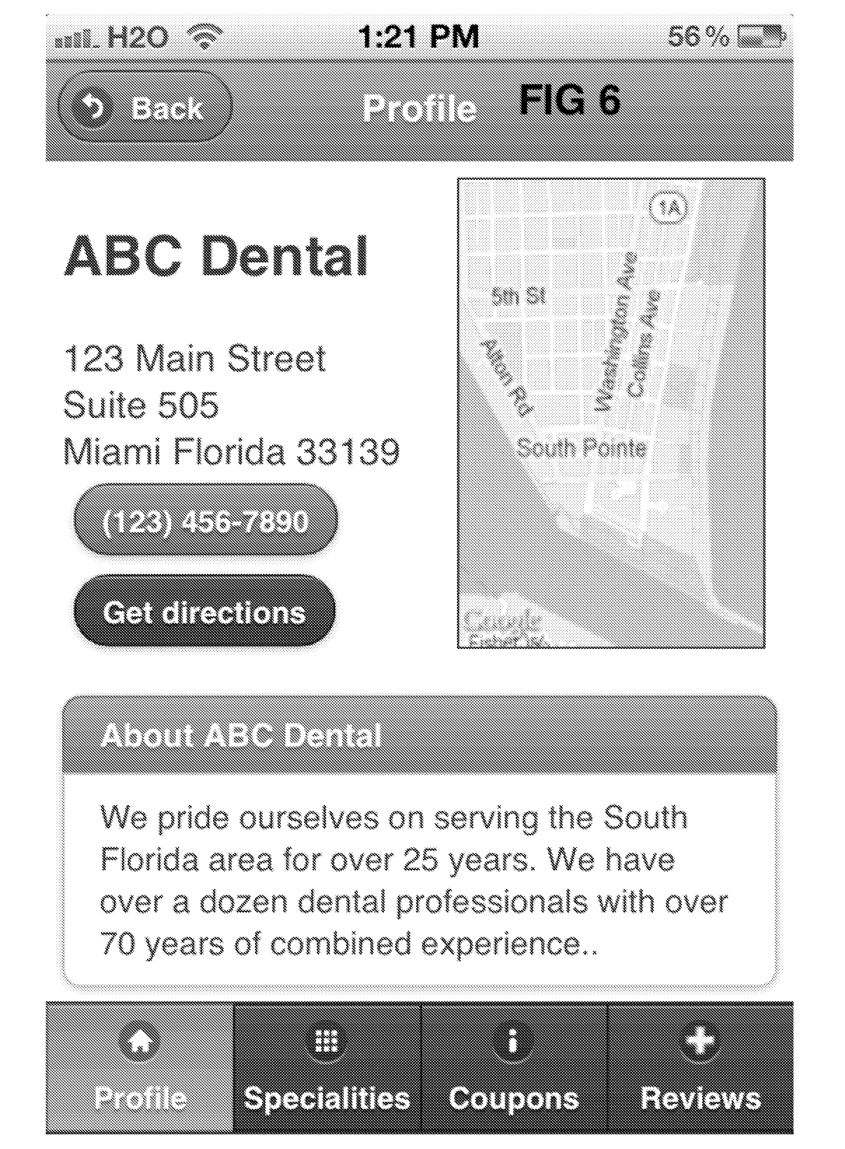

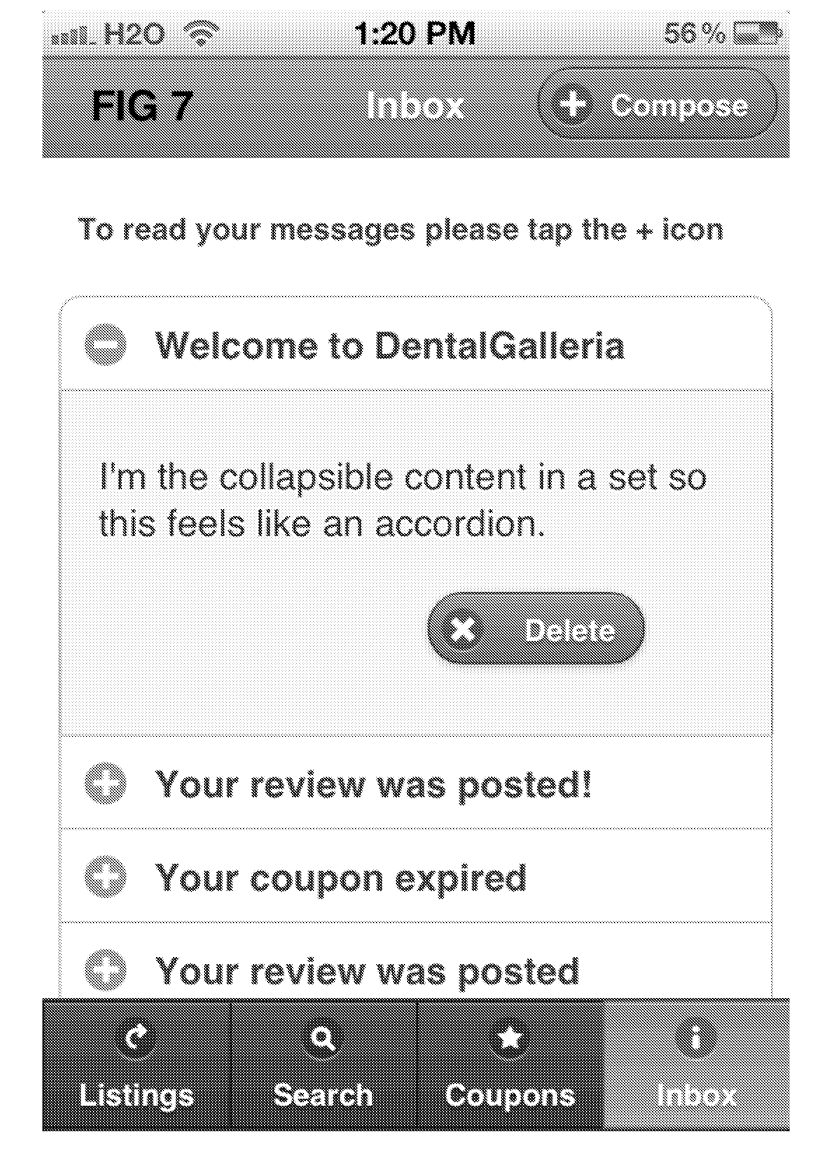

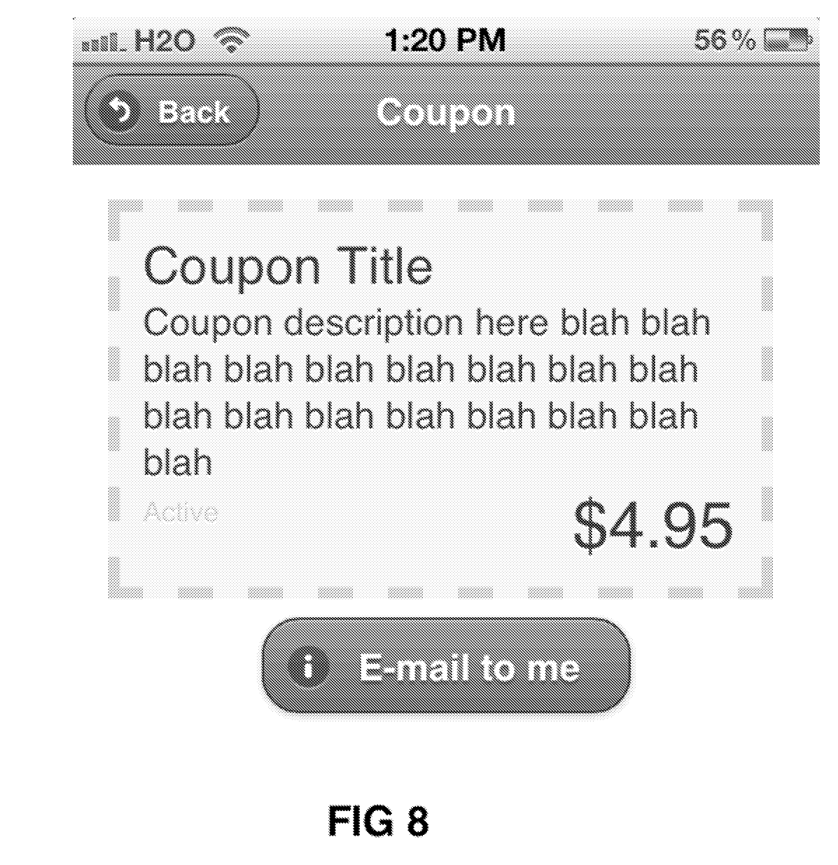

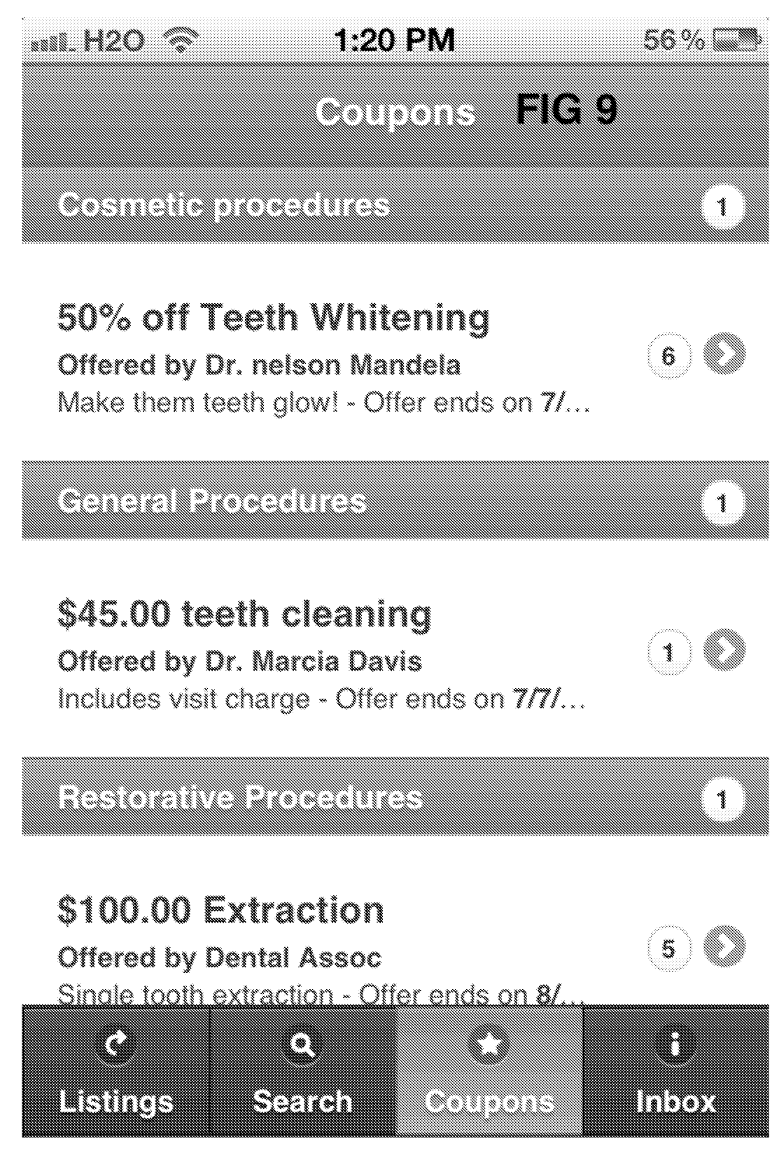

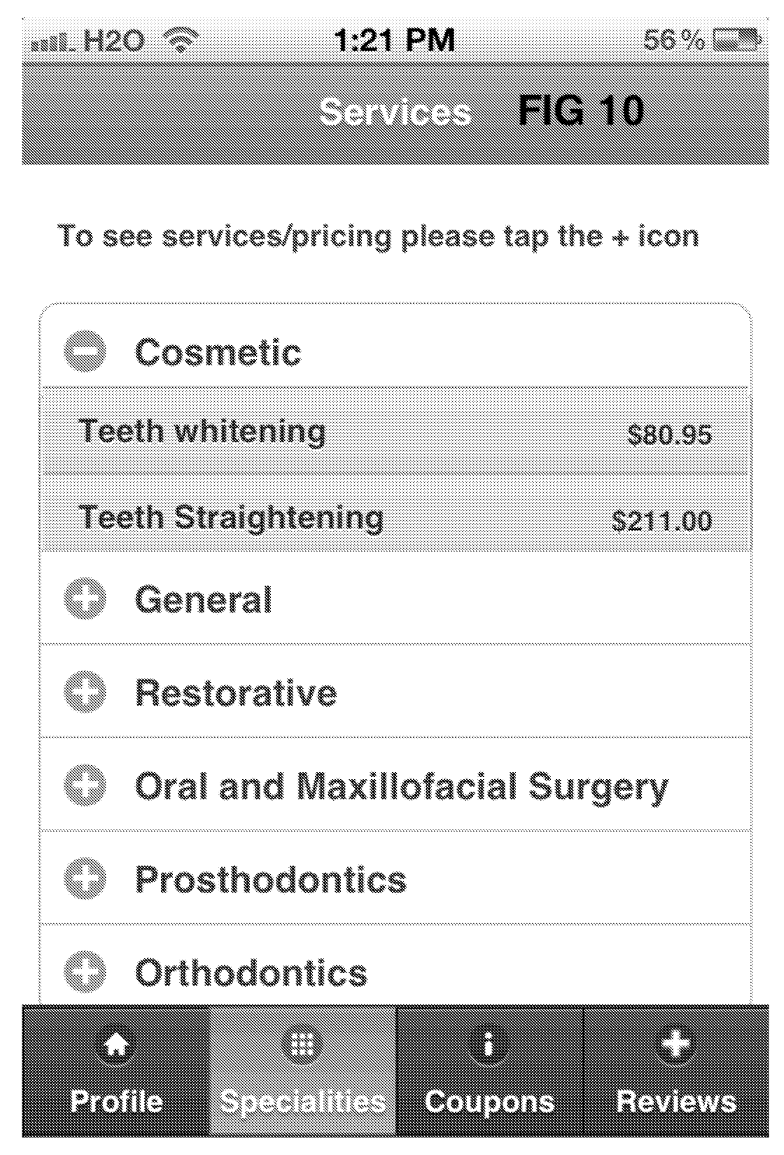

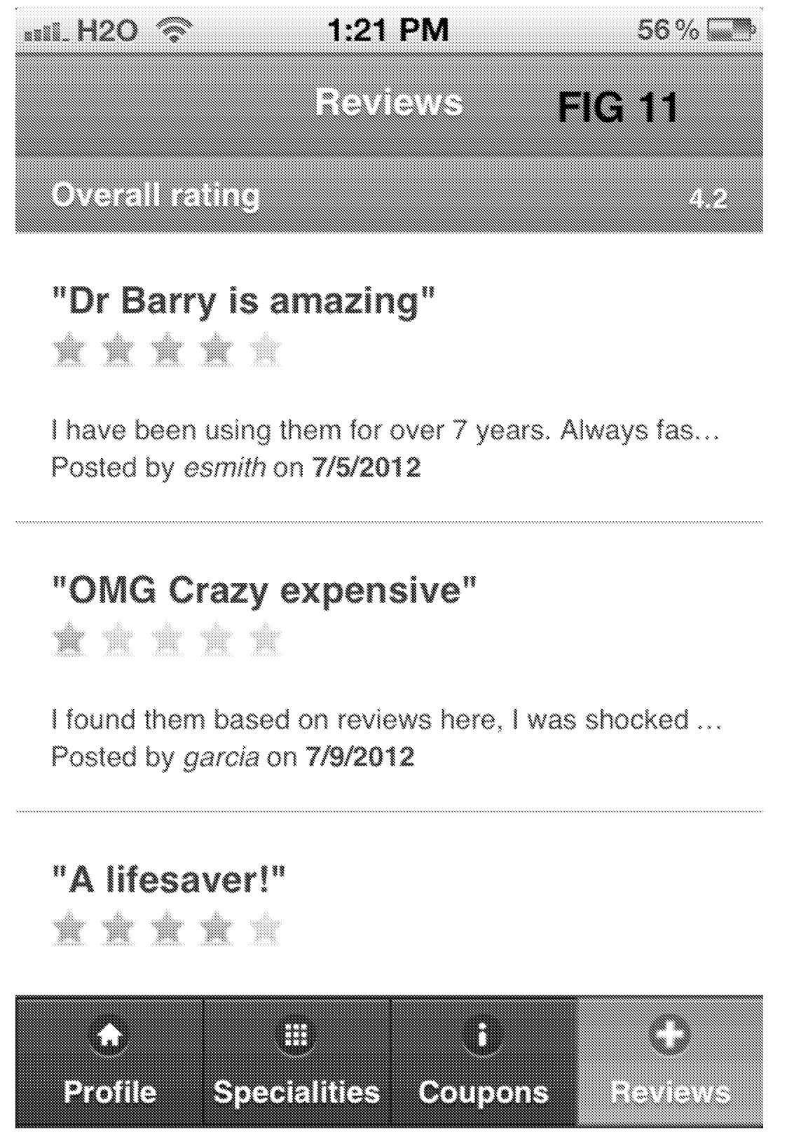

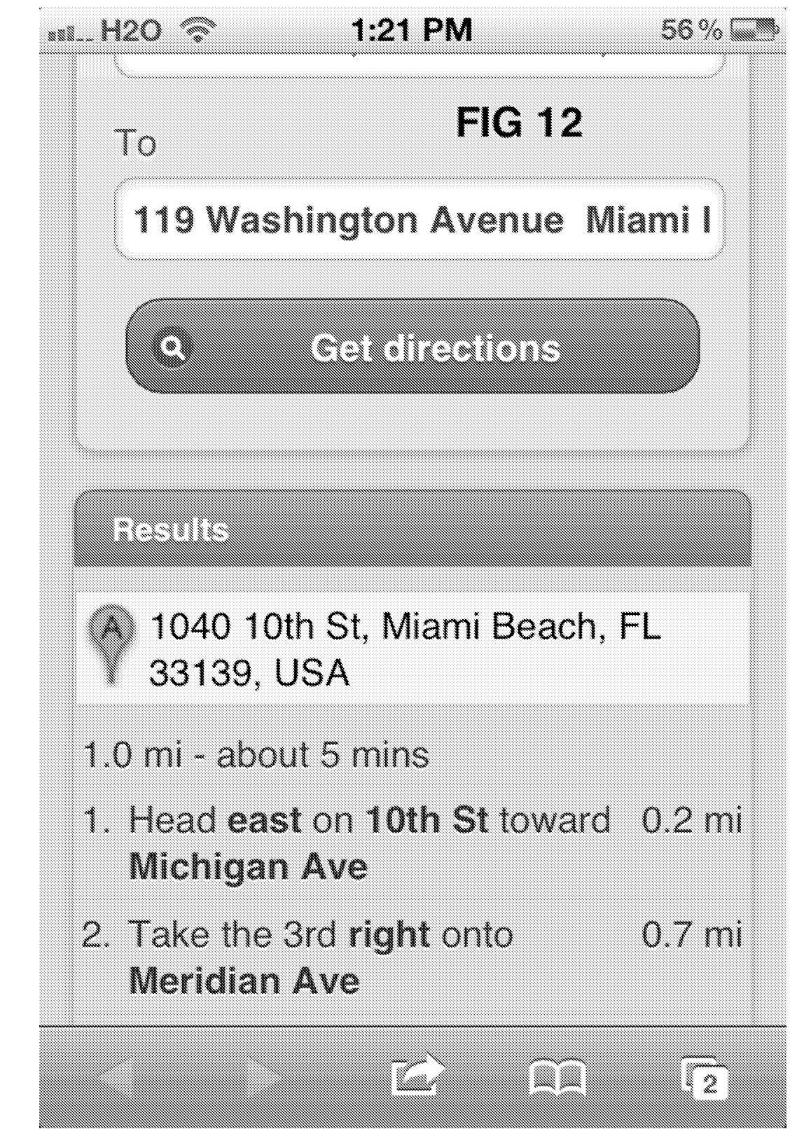

The smart phone device as demonstrated by the screen shots in FIGS. 1-12, provides the consumer information with which to make an informed decision. Further contemplated in the present invention is for the consumer to make an appointment directly with the dental office utilizing communication from the mobile computer device and the application operatively associated with the present invention. It is further contemplated that the user utilizing the application relating to the system and method of the present invention can additionally change and cancel appointments through the smart phone or mobile computing device. It is further contemplated that through the system and method of the present invention the dentist's office can send a reminder message relating to an appointment in the near future. The message can include, but would not be limited to, any one of a phone call, an email, a text message, wherein said message is either SMS or MMS messaging, or any other method of communication through the system of the present invention.

Additionally, in one embodiment, the dentist's office in sending a confirmation message can prompt for a reply. In one embodiment, this would be displayed as a text message whereby the consumer replies back to confirm an appointment.

Additionally, the application itself could open with a prompt asking the user to please confirm appointment now. In this manner the consumer receives a reminder of the appointment and the dentist is assured that the patient will arrive for the scheduled appointment.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for communication of dental information and selecting a dentist whereby said system comprises:
a program stored on a non-transitory computer readable medium configured for access by a computing device;
a central database whereby individual dentist offices register their dental office and information;
a consumer interaction portal whereby said portal includes at least one of information about a dental office based on location, consumer reviews, prices, available coupons and combinations thereof;
whereby said consumer accesses said dental database through an integrated application program on a mobile device.

2. The system of claim 1 wherein said consumer access includes restriction identifiers resulting in generation of a list from said database based on said restrictions.

3. The system of claim 1, wherein said dentist receives contact information based on views of office registration information.

4. The system of claim 1, wherein said consumer can schedule an appointment for a selected dentist.

5. A method of making a dental appointment, said method comprising the steps of:
providing a system of claim 1;
accessing said system by a patient or patient caregiver;
searching said system by selecting at least one search parameter;
outputting a list of providers based on the search parameters.
